(19) United States
(12) Patent Application Publication
(10) Pub. No.: US 2008/0300914 A1
(43) Pub. Date: Dec. 4, 2008

(54) DYNAMIC ACTIVITY MANAGEMENT

(75) Inventors: Chris Demetrios Karkanias, Sammamish, WA (US); Stephen Edward Hodges, Cambridge (GB)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/754,597

(22) Filed: May 29, 2007

(51) Int. Cl. A63B 71/00; G06Q 10/00

(52) U.S. Cl. 705/2; 482/9

(57) ABSTRACT

A system that facilitates management of physical activity by dynamically compensating for current conditions is provided. A user profile can be employed to automatically calibrate an activity device (e.g., treadmill, cycle, haptic brace) based upon characteristics and/or limitations of a user. User activity and other data (e.g., physiological data, motion data, environmental data) can be monitored and employed to dynamically recalibrate the activity device in an effort to optimize performance. Additionally, a simulation profile can be employed as a benchmark for performance. For example, actual user activity can be contrasted against the simulation profile in order to provide feedback, motivation, or even to facilitate dynamic calibration of an activity device throughout an exercise regimen.

### BACKGROUND

‘Working out’ often refers to an act of physical activity in an effort to promote healthy living. Today, there is an ever-growing emphasis on healthy living, and accordingly, physical activity. Generally, many people regularly ‘workout’ in an effort to control weight gain, build muscle mass, rehabilitate injuries, prevent injuries or even to provide an outlet for stress or social connections. For example, many professionals regularly incorporate a visit to the health club into their hectic work schedule as a way to regulate stress, keep fit while at the same time adding social aspects to their busy days. No matter the reason, working out is at the forefront for many people in today's society to live a healthier life as well as to look and feel better while doing it.

Working out, or physical exercise, most often refers to performance of some activity in order to achieve physical fitness or maintain overall good health. For instance, working out can range from anaerobic exercise to aerobic exercise. With regard to anaerobic activity, working out can include weight training or resistance training to develop or increase muscle strength. Aerobic exercise focuses on developing or increasing cardiovascular endurance and/or weight loss. In addition to anaerobic and aerobic exercise, many individuals engage in a regular routine of flexibility exercises which improve the range of motion of joints and muscles.

In addition to developing and increasing muscle strength/tone, cardiovascular endurance and flexibility, working out is often used to prevent health-related injuries and/or diseases. By way of example, a regular physical exercise routine is an important component in the prevention of some diseases such as cardiovascular disease, heart disease, diabetes, obesity, among others.

Of course, the type of physical activity and corresponding desired results may not be consistent between individuals. For example, one individual may be interested in building muscle mass (e.g., anaerobic) while another may be interested in enhancing cardiovascular endurance or weight loss (e.g., aerobic). However, a common thread of healthy living is regular physical activity whether it be anaerobic, aerobic or flexibility training. Moreover, today, some individuals are constantly ‘battling the bulge’ or the ‘rollercoaster of weight’ by trying to exercise by adhering to rigorous workout routines.

In order to be effective, most workout regimens or routines require individuals to manually record progress by journaling repetition counts, weight amounts, distances, etc. For example, weight training involves many different exercises that focus on different muscles or groups of muscles. Additionally, the amount of weight used and the number of repetitions completed dictate and yield different results. For instance, heavier weight with a lower number of repetitions tends to build muscle mass while lighter weight with an increased number of repetitions shares some of the effects of aerobic training, e.g., toning and weight loss. Thus, it is critical that a particular routine be tailored to achieve desired results. Unfortunately, oftentimes individuals do not possess the necessary knowledge to formulate an effective workout routine to achieve a desired result. Regardless of the routine, an additional problem is that many people lose interest and do not possess the drive to accomplish an effective workout.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that facilitates management of physical activity. In one aspect, a user profile can be employed to automatically calibrate an activity device (e.g., treadmill, cycle, haptic brace). The user profile can be manually entered or inputted by way of indicia such as a barcode, magnetic strip, radio frequency identification tag, universal serial bus (USB) memory stick or the like.

User activity and other data (e.g., physiological data, motion data, environmental data) can be monitored and employed to dynamically recalibrate the activity device in an effort to optimize performance. For example, by monitoring a user's performance and physiological characteristics, the activity apparatus can be dynamically adjusted to increase effort while maintaining a safe zone that minimizes probability of harm. Essentially, the dynamic compensation functionality can act as a virtual coach to promote rehabilitation, strength training, weight loss, stamina increase, or the like.

In another aspect of the subject innovation, a simulation profile can be employed as a benchmark for performance. In one embodiment, actual user activity can be contrasted against the simulation profile in order to provide feedback and/or motivation with regard to performance. In another embodiment, the simulation profile can be used to facilitate dynamic calibration of an activity device throughout an exercise regimen.

In yet another aspect thereof, a machine learning and reasoning component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates managing physical activity in accordance with an aspect of the innovation.

FIG. 2 illustrates an example flow chart of procedures that facilitate comparing actual activity to a simulation in accordance with an aspect of the innovation.

FIG. 3 illustrates an example flow chart of procedures that facilitate dynamically adjusting an activity device in accordance with an aspect of the innovation.

FIG. 4 illustrates an example flow chart of procedures that facilitate obtaining additional data associated with activity data in accordance with an aspect of the innovation.

FIG. 5 illustrates an example device configuration component that employs a simulation component and a profile input component to configure an activity device in accordance with an aspect of the innovation.

FIG. 6 illustrates an example dynamic compensation component that facilitates active monitor and analysis in furtherance of dynamic calibration in accordance with an aspect of the innovation.

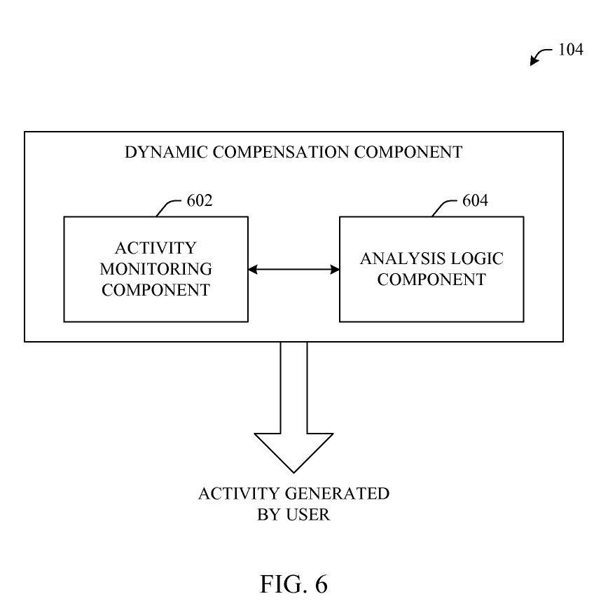

FIG. 7 illustrates an example activity monitoring component that gathers information from one or more sensors in accordance with an aspect of the innovation.

FIG. 8 illustrates an example simulation component that compares actual activity data to a simulation profile and renders the comparison in accordance with an aspect of the innovation.

FIG. 9 illustrates an architecture that includes machine learning and reasoning-based component that can automate functionality in accordance with an aspect of the novel innovation.

FIG. 10 illustrates a block diagram of a computer operable to execute the disclosed architecture.

FIG. 11 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

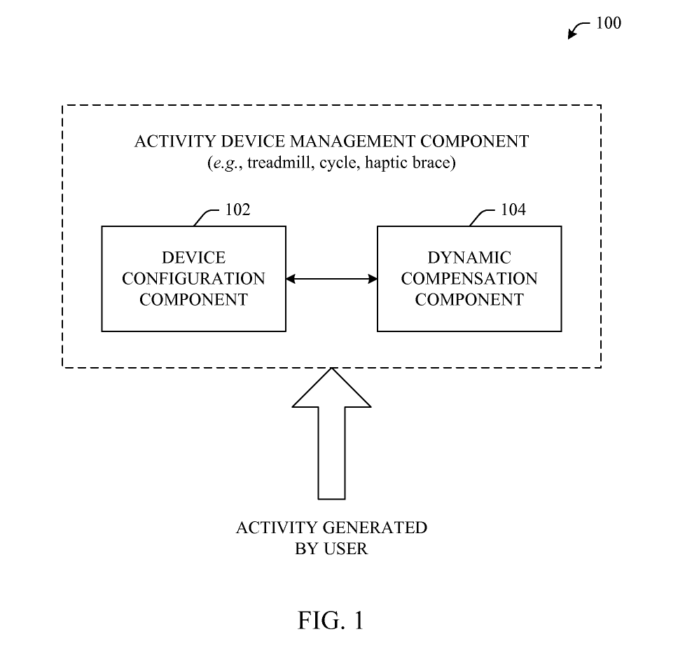

Referring initially to the drawings, FIG. 1 illustrates a system 100 that facilitates managing physical activity in accordance with an aspect of the innovation. Generally, in an embodiment, system 100 can include a device configuration component 102 and a dynamic compensation component 104 that together enable calibration and recalibration in accordance with a profile and real-time motion response. Each of these components will be described below with reference to the figures that follow.

Device configuration component 102 enables an activity device to be automatically configured or calibrated in accordance with a predefined or preprogrammed profile. For instance, a health-care professional such as a physical therapist or personal trainer can establish a profile for a user which includes a regimen for the user to follow when exercising. As used herein, an ‘activity device’ is intended to include most any device that is used for exercise or active motion generally. As such, an ‘activity device’ is to include, but is not intended to be limited to, a treadmill, an exercise cycle, a step/stair climber, an elliptical apparatus, an ergo, a cross trainer, a haptic brace and other sensory equipped devices.

In other examples, the profile can be that of a third party. For instance, the profile can be established to represent a professional athlete that the user desires to mimic. In one scenario, the professional athlete's profile can be employed to calibrate the activity device in accordance with criteria indicative of the subject professional athlete. In another scenario, the profile of the professional athlete can be used as a benchmark by which actual user data can be compared and rendered.

In a more detailed example, a user can input their personal profile thereby calibrating the activity device with desired parameters. In an aspect, this profile can be searched for and entered from an internal memory. In other aspects, the user can input the information manually or can employ indicia such as a barcode scanner, magnetic card reader, radio frequency identification tag (RFID) reader, universal serial bus (USB) memory device or the like to input.

Similarly, a profile of a third party (e.g., professional athlete) can be input in an analogous manner, for example manually entered from an internal memory or input from a suitable identifying indicia. Although the examples described herein refer to the third party as a professional athlete, it is to be understood that the simulation profile can be associated to a professional athlete, a disparate amateur individual or even an imaginary individual. These additional examples are to be included within the scope of this disclosure and claims appended hereto.

Once the profile (or profiles) is employed to calibrate the activity device, the dynamic compensation component 104 can be employed to actively reconfigure or re-calibrate the device as a function of performance data related to the user. Continuing with the aforementioned example, suppose the user configures a treadmill with his/her personal profile. Thus, the treadmill will be calibrated with parameters such as speed, inclination, program factors and the like.

Additionally, consider that a simulation profile of a friend is uploaded into the treadmill. Here, the dynamic compensation component 104 can be employed to monitor motion of the user thereafter recalibrating the treadmill to promote alignment with the simulation profile. Moreover, it is possible to graphically display the user performance in contrast with the simulation profile. In other words, the simulation profile can be used as performance benchmark that motivates the user to increase performance.

To further add context to the innovation, an exerciser can race (or otherwise compete) against other users. For instance, the innovation can employ ‘cloud’ or network-based information and communication techniques to enable functionality described herein. These ‘cloud’ embodiments can leverage availability of and comparison between many users connected to a suitable network. This could enable dynamic real-time ‘racing’ of users, either directly (e.g., same type of machine, like-for-like comparison of performance) or through a mapping that accounts for a users ‘handicap’ and can even allow a user on a cross-trainer to compete with another using an elliptical exerciser, for example. The ‘handicapping’ can be accomplished entirely in software (e.g., by cross-calibrating the performance statistics that come from a machine) or could involve dynamically adjusting the machines to make the exercise easier/harder, for example, by adding more resistance for the fitter person to make them work harder.

A haptic brace example could also use the ‘handicap’ scenario. For instance, rather than giving a user a handicap through interpretation of the data from a machine or through control of the machine, the innovation enables a haptic brace to dynamically assist a user or to make it harder for them, thus, compensating as a ‘handicap’. Thus, the machine would not have to be altered at all.

Moreover, the system 100 can employ logic that can dynamically pair up users with others of similar ability. The ‘cloud’ could also maintain records of previous data sets for non-real time comparison (e.g., allow a user to race against their previous performance on a given machine, or that of a friend who was not exercising contemporaneously). Additionally, the ‘cloud’ could make certain ‘celebrity’ type profiles available for racing (or competing) against.

The dynamic pairing of and competition between users could be extended to teams (e.g., either real or virtual) as well as across an entire exercise ‘session’ rather than just for a specific machine. These teams could be created dynamically. Thus, when the exerciser gets to the gym, he/she becomes part of a team that is competing with other teams for the entire workout time. It can be possible to view the performance of specific members of a team as desired. It can also be possible to talk to or otherwise communicate with each other exercisers.

While specific examples are described, it is to be understood that these examples are included merely to add perspective to the innovation and are not intended to limit the innovation in any way. As such, it is to be understood that additional examples exist that employ the described features, functions and benefits of the innovation. These additional examples are to be included within the scope of the innovation and claims appended hereto.

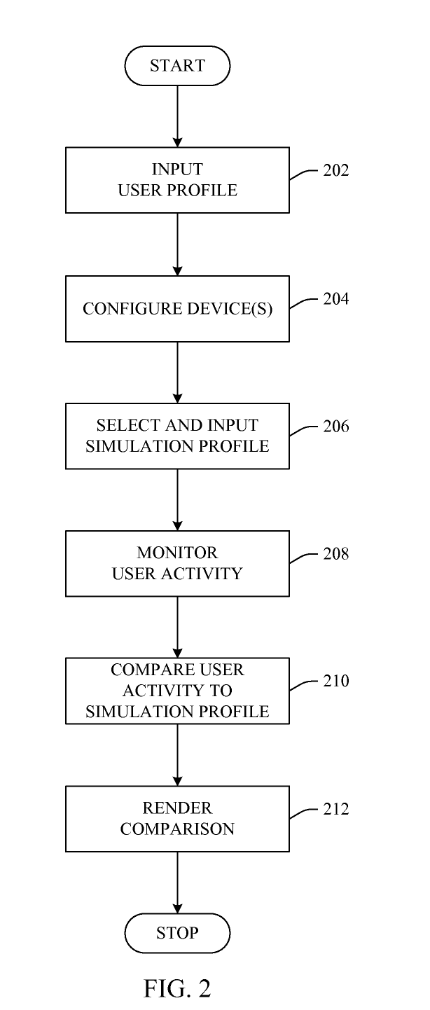

FIGS. 2, 3, and 4 illustrate methodologies of managing physical activity in accordance with aspects of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring first to FIG. 2, at 202 a user profile can be input or entered into the system. Here, this act can include manual selection of parameters of a particular workout regimen, physical characteristics of a user, etc. In other aspects, the profile can be communicated into the system via identifying indicia. For instance, a scanner can be used to read a barcode which has the profile information encoded therein. In another aspect, a magnetic card reader can be used to capture the profile information from a magnetic strip, such as on a driver's license or health club membership card. Most any indicia including, but not limited to a USB memory fob, RFID tag reader, etc., can be used to transfer the profile information to an activity device.

It is to be understood that the predefined profile information can enable a user to receive a prescribed regimen from a third party such as a coach, heath-care professional, personal trainer, or the like. As well, this indicia enables a user to build upon previous exercise sessions by providing a sophisticated manner in which information can be captured and retrieved. In some embodiments, data can be captured before, during or after a workout and thereafter saved into a health-care journal for analysis.

It is to be understood that this captured data can be employed to logically define or program profile data that can be used in accordance with the innovation. As described above, a third party (e.g., coach, health-care professional) can analyze the captured information to assess progress, status, or the like. This information can be used to establish the user profile information which can be used to configure an activity device at 204.

At 204, the activity device (or group of devices) is configured in accordance with the loaded profile. Here, the activity device (e.g., treadmill) can be calibrated in accordance with a desired or prescribed regimen. It is to be understood that logic can be provided to configure more than one device as a function of information contained within the profile.

By way of example, suppose a user workout includes both aerobic and anaerobic exercises. Here, the profile can define parameters associated to both aerobic and anaerobic equipment. Accordingly, more than one device can be configured or calibrated at 204. Similarly, logic can be employed to stagger the timing of calibration in accordance with a user regimen. For instance, if the user is to be on the treadmill for 30 minutes, the next device will automatically be calibrated just prior to the 30 minute time window.

At 206, a simulation profile can be selected. As described above with regard to the user profile, the simulation profile can be selected and input manually (e.g., from a storage device) or identifying indicia. This simulation profile can be representative of a professional athlete, friend, imaginary character, or the like. In all, the simulation profile represents a benchmark that motivates the user while exercising.

At 208, user activity is monitored, for example, by way of sensors or the like. Here, the monitored activity can include physiological as well as device mechanics characteristics. In other words, physiological characteristics can be captured while exercising together with actual motion criteria. This information can be synchronized so as to enable analysis of the physiological characteristics in accordance with actual exercise motion.

This activity information can be compared to the simulation profile selected at 206. In operation, it is possible to determine how the user performance compares to the selected simulation profile. Thus, the comparison can be rendered at 212. More particularly, the comparison can be rendered to a user via a display to graphically depict how the user's performance compares to that of a simulation profile.

In other embodiments, the comparison can be rendered and employed to recalibrate the activity device so as to promote competition or consistency with the simulation profile. For instance, continuing with the above example, the treadmill can be recalibrated so as to promote a pace and/or level of activity that meets or exceeds that of a selected simulation profile. Moreover, a graphical display can present a comparison as well as projections related to the actual user activity in view of the simulation profile.

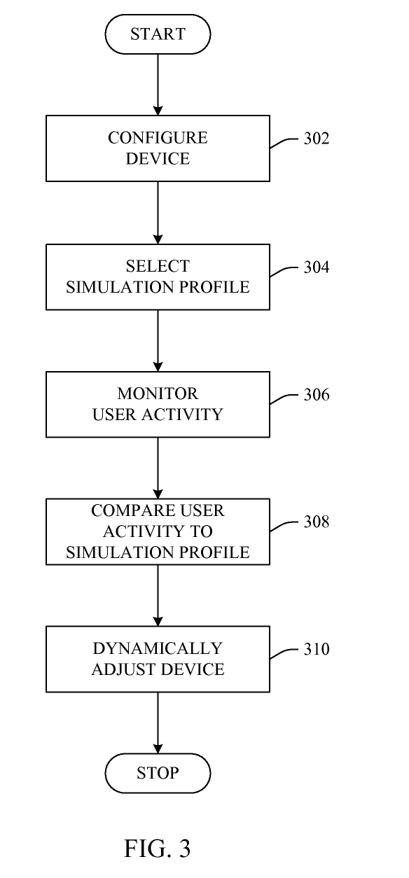

Referring now to FIG. 3, there is illustrated a methodology of calibrating an activity device in accordance with an aspect of the innovation. At 302, the device can be configured (e.g., calibrated). As described supra with reference to FIG. 2, the activity device can be configured manually, in accordance with a defined profile or a combination thereof. In an example, a barcode or other indicia (e.g., magnetic strip, RFID tag) can be scanned into the activity device thereby transferring preprogrammed or predefined information into the system.

At 304, a simulation profile can be selected. Similar to the user profile, the simulation profile can be selected from a store (e.g., hard disk, cloud-based store), manually entered or entered by employing a predefined or preprogrammed indicia. The simulation profile can include information related to performance (e.g., statistics), stamina, regimen, or the like. Most any definable characteristic or statistic can be included within the simulation profile.

User activity can be monitored at 306 which provides a baseline of actual user performance. In an example, sensors applied to a haptic brace can provide motion data which can be compared to the simulation profile at 308. In this act, most any data can be compared including but, not limited to, performance data (e.g., motion, pace, speed, weight amount, number of repetitions, inclination, etc.), physical characteristics (e.g., heart rate, blood pressure, body temperature, hydration levels, etc.), historical performance levels, performance levels of similar individuals with comparable age, weight, etc. Essentially, the simulation profile can be employed to act as a performance benchmark.

Thus, at 310, the device can be automatically recalibrated to adhere to the simulation profile benchmark. In other words, criteria can be adjusted dynamically throughout a user's workout to emulate a similar workout by the simulated profile. For instance, suppose a user wants to run a 10K at a pace of last year's winner of a specific event. Here, the profile of last year's winner can be uploaded as a simulation profile. Thus, while the user is running the course, the treadmill can automatically adjust to motivate the user to mimic (or as closely as possible mimic) the winner's pace.

It is to be understood that the system can intelligently consider the user profile and limitations when dynamically adjusting. For example, if a user's strength is running in the first 5K, the system may recalibrate the device to be more demanding in the first 5K so as to allow for stamina lag in the second 5K. In all, logic of the device can be used to dynamically compensate for strengths and weaknesses of a user.

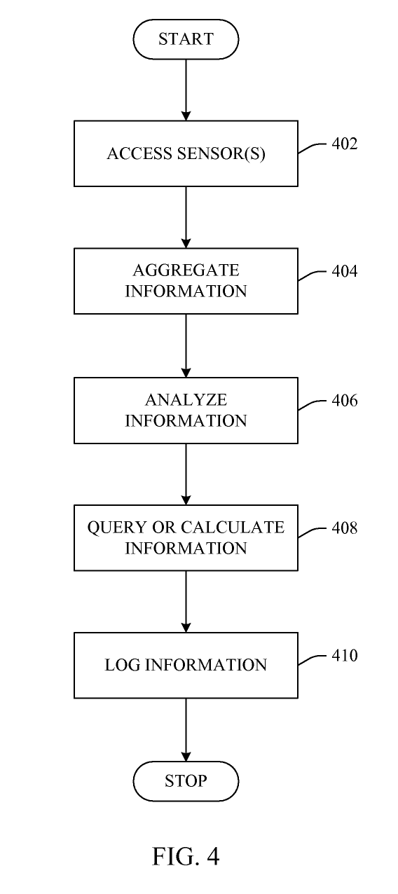

Referring now to FIG. 4, a flowchart of a methodology of aggregating information in accordance with the innovation is shown. More particularly, at 402, sensors can be accessed. These sensors can include motion sensors which establish ranges of motion, amount of weight lifted, number of times lifted, distance traveled, inclination, etc. Physiological sensors can be accessed to establish effect upon a user's body such as stamina, muscle status, heart rate, blood pressure, body temperature, hydration level, etc. Still further, environmental sensors can be employed to establish environmental conditions such as ambient temperature, relative humidity, wind effects, ultraviolet (UV) ratings, etc. All, or a portion of, this data can be aggregated at 404 and analyzed at 406.

For example, at 406, the data can be analyzed to determine optimum performance capabilities of a user. Additionally, at 406, the information can be analyzed against a simulation profile if desired. Still further, additional information can be obtained by way of a query or calculation at 408. For example, identification of the number of calories burned by a user as a result a particular activity level can be queried and/or calculated at 408.

The information can be logged at 410 for analysis or use in future analysis. This information can be logged into a data store or stored upon identifying indicia (e.g., bar code, magnetic strip). As such, the information can be easily transferred to a target device for journaling or analysis.

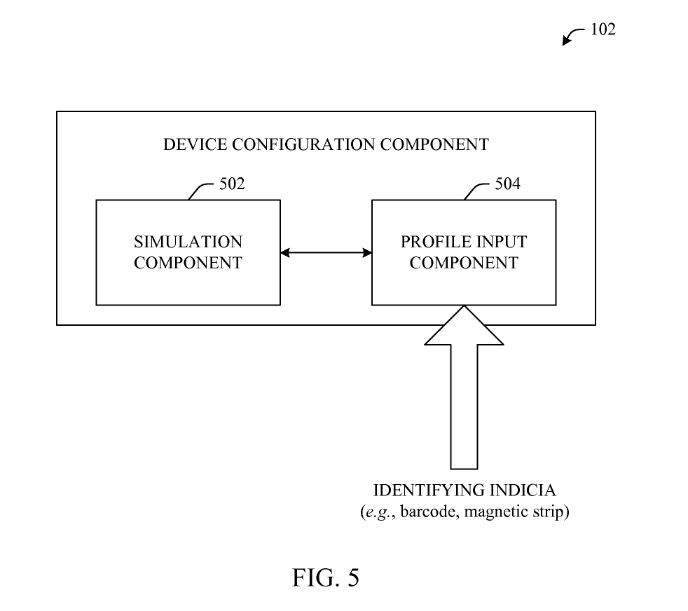

FIG. 5 illustrates an example block diagram of a device configuration component 102 in accordance with an aspect of the innovation. Generally, the device configuration component 102 can employ a simulation component 502 and/or a profile input component 504 to calibrate or configure an activity device such as a treadmill, cycle, etc. Although both components are shown integral to the device configuration component 102, it is to be understood that each of the components (502, 504) can be employed independently of the other without departing from the spirit and scope of the innovation and claims appended hereto.

The profile input component 504 enables entry of a profile into the system, which can later be employed to calibrate an activity apparatus or device. As described supra, the profile can be a user profile or a third party profile which can be used by the simulation component 502 to contrast or promote activity. In either case, the profile can include most any criteria associated with activity such as an exercise regimen, motion data, stride/gait data, stamina data, physiological data, historical performance data or the like.

The simulation component 502 can be used to compare and/or contrast the user activity with the simulation or third party profile data. Thus, the simulation component 502 can essentially become a virtual coach by rendering the comparison and providing feedback to assist the user in reaching a desired goal, as defined by the profile(s). This feedback can be generated or delivered in most any manner including visual display or audible commands.

The dynamic compensation component 104 can include an activity monitoring component 602 and an analysis logic component 604. In operation, the activity monitoring component 602 can obtain data in real-time, for example from sensory mechanisms. Accordingly, the analysis logic component 604 can analyze the received data and process or convert the data into a common format consistent with the profile data. As well, the logic component 604 can aggregate the information to enable the simulation component 502 to more efficiently establish a comparison.

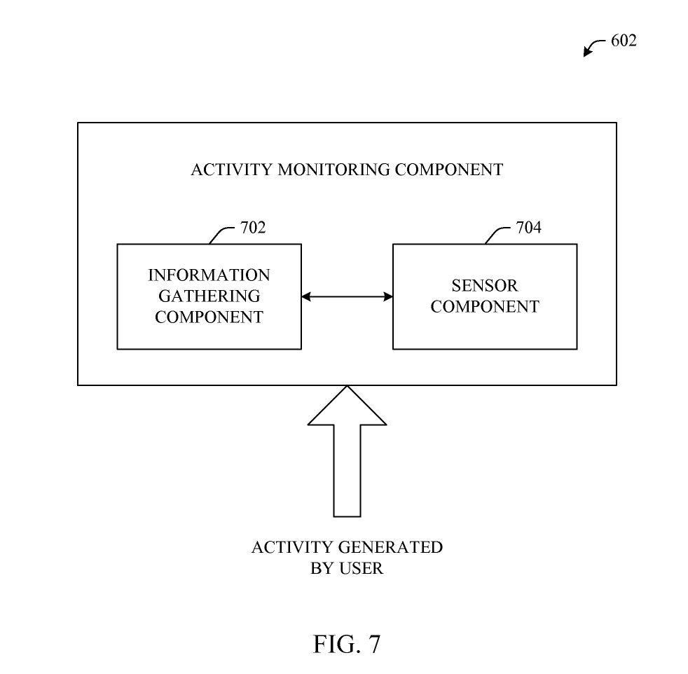

Drilling down even further, FIG. 7 illustrates a block diagram of an activity monitoring component 602 in accordance with an aspect of the innovation. As shown, the component can include an information gathering component 702 that obtains information from a sensor component 704. While the sensor component 704 is shown inclusive of the activity monitoring component 602, it is to be understood that this sensor component 704 can be remotely located and can include one or more sensory mechanisms capable of monitoring and capturing data related to activity, physiological responses, environmental conditions or the like.

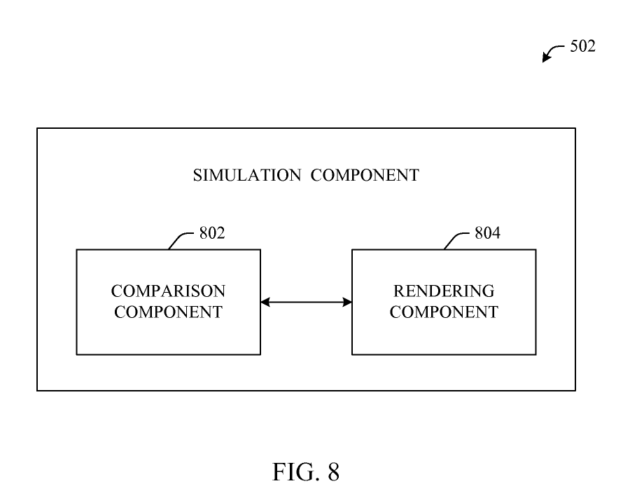

As such, the information gathering component 702 can be employed to aggregate information from most any sensory mechanisms. This information can be transferred to the simulation component 502 for analysis and/or communication. An example simulation component is illustrated in FIG. 8.

Referring to FIG. 8, the simulation component 502 can include a comparison component 802 and a rendering component 804. As described above, the comparison component 802 can contrast actual activity data with a selected simulation profile. Accordingly, the rendering component 804 can communicate the comparison to a user or other target destination. This communication can be in most any manner known in the art, for example, visual or audible delivery.

In other examples, the rendering component 804 can facilitate saving the comparison data as well as the monitored data onto an identifying indicia, such as a barcode, magnetic strip, RFID tag or the like. As described above, these identifying indicia can be used to input the data into the system at a later time as well as to establish a journal of physical activity. This journal can be used to assess or promote progress, reaching a goal with respect to rehabilitation, strength training, weight loss, etc.

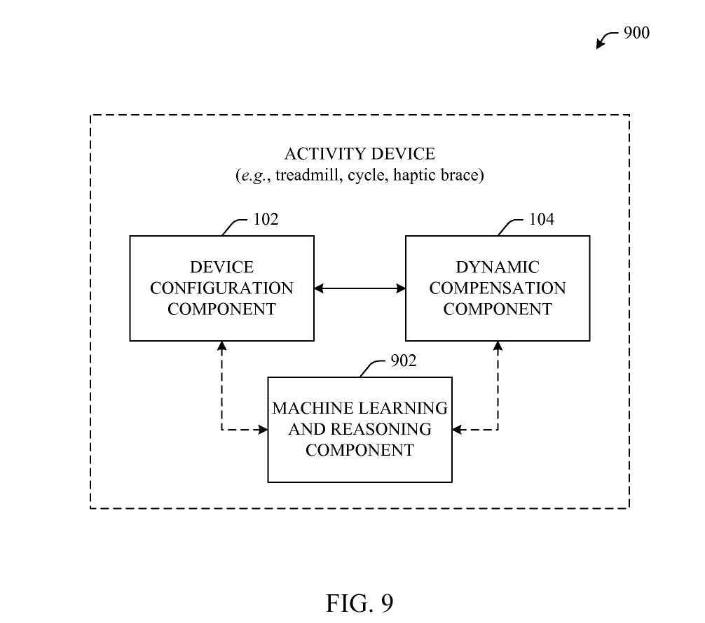

FIG. 9 illustrates a system 900 that employs a machine learning and reasoning (MLR) component 902 which facilitates automating one or more features in accordance with the subject innovation. The subject innovation (e.g., in connection with profile selection) can employ various AI-based schemes for carrying out various aspects thereof. For example, a process for determining which profile to select to achieve a goal can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria which profile to select or how to dynamically recalibrate an activity device in a given situation or to achieve a particular goal.

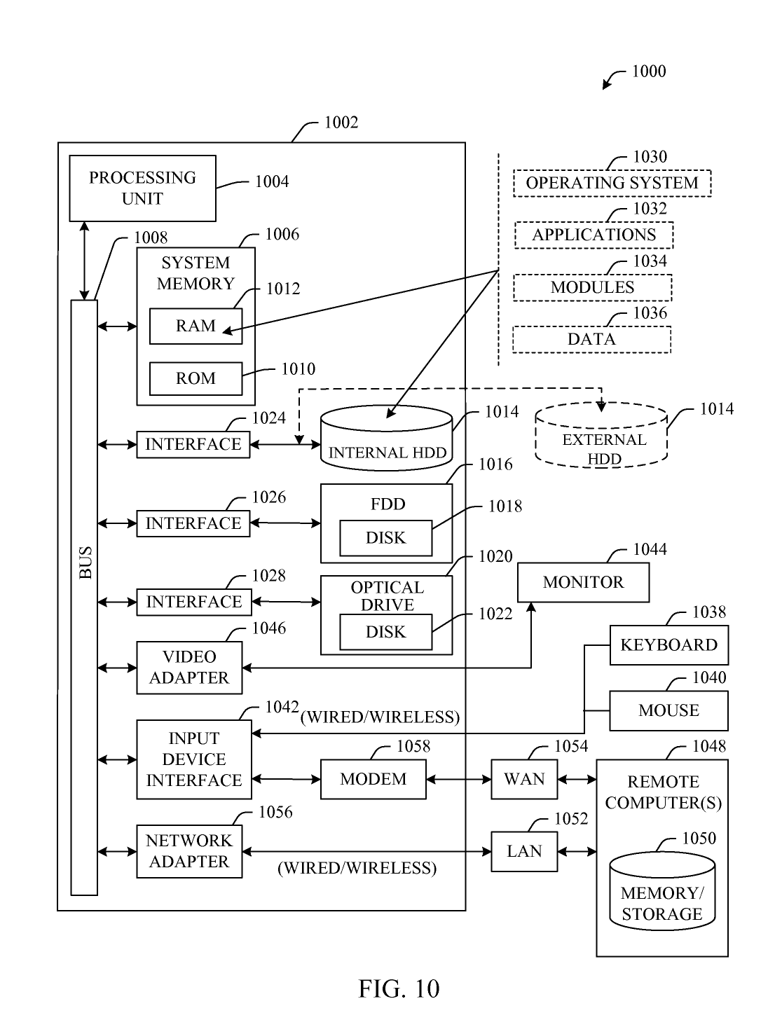

Referring now to FIG. 10, there is illustrated a block diagram of a computer operable to execute the disclosed architecture. In order to provide additional context for various aspects of the subject innovation, FIG. 10 and the following discussion are intended to provide a brief, general description of a suitable computing environment 1000 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the innovation includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the innovation can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

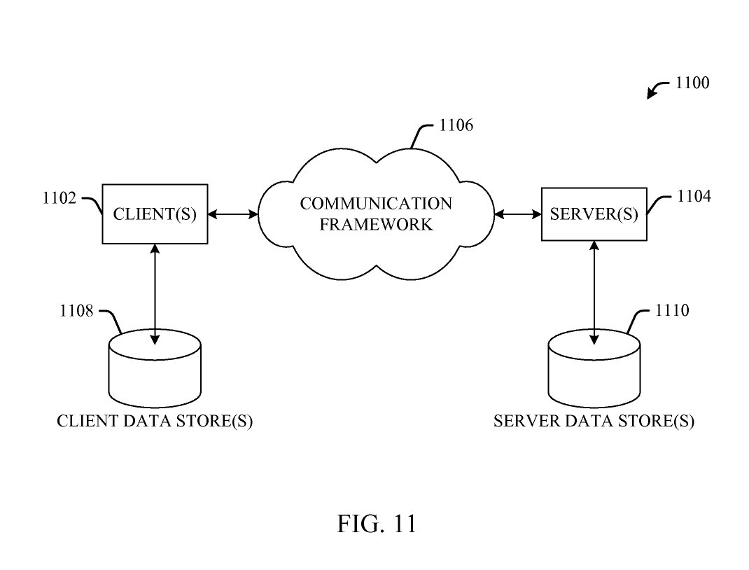

Referring now to FIG. 11, there is illustrated a schematic block diagram of an exemplary computing environment 1100 in accordance with the subject innovation. The system 1100 includes one or more client(s) 1102. The client(s) 1102 can be hardware and/or software (e.g., threads, processes, computing devices). The client(s) 1102 can house cookie(s) and/or associated contextual information by employing the innovation, for example.

The system 1100 also includes one or more server(s) 1104. The server(s) 1104 can also be hardware and/or software (e.g., threads, processes, computing devices). The servers 1104 can house threads to perform transformations by employing the innovation, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates management of physical activity, comprising:
a device configuration component that calibrates an activity device as a function of a profile;
a dynamic compensation component that recalibrates the activity device as a function of user motion, physiological parameter or environmental data;
a simulation component that replicates third party statistics, wherein the third party statistics are employed as a benchmark of the physical activity;
a comparison component that compares and contrasts the benchmark with the user motion or physiological parameter data; and
a rendering component that communicates the contrast to a user and provides feedback to assist the user in reaching a desired goal, wherein the contrast stimulates motivation to the user; and
wherein network-based information and communication techniques are employed to leverage availability of and comparison between a plurality of users connected to a network to enable dynamic real-time competing of users, either directly or through a mapping that accounts for a users handicap.

2. (canceled)

3. (canceled)

4. The system of claim 1, the activity device is at least one of a treadmill, aerobic training machine, weight training machine, stair/step exerciser, elliptical exerciser, ergo, cross trainer or haptic brace.

5. The system of claim 1, wherein the simulation component dynamically pairs the user with a third party based at least in part upon ability.

6. The system of claim 1, further comprising a profile input component that accepts the profile, wherein the profile is incorporated into an identifying indicia.

7. The system of claim 6 wherein the profile input component is a scanner and the identifying indicia is a barcode.

8. The system of claim 6 wherein the profile input component is a magnetic card reader and the identifying indicia is a magnetic strip.

9. The system of claim 1, further comprising an activity monitoring component the monitors and obtains the user motion or physiological parameter data.

10. The system of claim 9, further comprising:
a sensor component that generates activity information, wherein the activity information is the at least one of user motion or physiological parameter data; and
an information gathering component that accesses the activity information from the sensor component.

11. The system of claim 9, further comprising an analysis component that evaluates the user motion or physiological parameter data and determines appropriate action by the dynamic compensation component.

12. The system of claim 1, further comprising a machine learning and reasoning component that employs at least one of a probabilistic and a statistical-based analysis that infers an action that a user desires to be automatically performed.

13. A computer-implemented method of regulating physical activity, comprising:
selecting a simulation profile;
monitoring user activity via an activity device;
comparing the user activity with the simulation profile;
rendering the comparison and providing feedback to assist a user in reaching a desired goal; and
employing network-based information and communication techniques to leverage availability of and comparison between a plurality of users connected to a network to enable dynamic real-time competing of users, either directly or through a mapping that accounts for a users handicap.

14. The computer-implemented method of claim 13, further comprising calibrating the activity device in accordance with the comparison.

15. The computer-implemented method of claim 13, further comprising:
inputting a user profile; and
calibrating the activity device as a function of the user profile.

16. The computer-implemented method of claim 15, further comprising:
querying a network source for performance data related to the user activity; and logging the user activity and performance data.

17. The computer-implemented method of claim 13, wherein the activity device is at least one of a treadmill, aerobic training machine, weight training machine, stair/step exerciser, elliptical exerciser, ergo, cross trainer or haptic brace.

18. A computer-executable system, comprising:
means for calibrating an activity device in accordance with a user profile;
means for monitoring motion of a user via the activity device;
means for comparing the motion to a simulation profile, wherein the simulation profile relates to a third party;
means for rendering the comparison to a user and means for providing feedback to assist the user in reaching a desired goal; and
means for employing network-based information and communication techniques to leverage availability of and comparison between a plurality of users connected to a network to enable dynamic real-time competing of users, either directly or through a mapping that accounts for a users handicap.

19. The computer-executable system of claim 18, further comprising means for recalibrating the activity device based at least in part upon the comparison.

20. The computer-executable system of claim 18, further comprising means for logging data related to the motion and the comparison.
